(19) United States
(12) Patent Application Publication
(10) Pub. No.: US 2009/0108915 A1
(43) Pub. Date: Apr. 30, 2009

(54) Charge Pump System and Method of Operating the Same

(75) Inventor: Wei-Chien Liao, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/031,835

(22) Filed: Feb. 15, 2008

(30) Foreign Application Priority Data
Oct. 31, 2007 (TW) 96141041

(51) Int. Cl. G05F 1/10

(52) U.S. Cl. 327/536

(57) ABSTRACT

A charge pump system includes a charge pump circuit, a level shifter and a start circuit. The charge pump circuit has a voltage input terminal and a voltage output terminal. The charge pump circuit receives an input voltage at the voltage input terminal and generates an output voltage at the voltage output terminal. The level shifter is electrically coupled to the voltage output terminal of the charge pump circuit. The start circuit is electrically coupled between the voltage input terminal and the voltage output terminal of the charge pump circuit. A method of operating the charge pump system is also disclosed.

### RELATED APPLICATIONS

This application claims priority to Taiwan Patent Application Serial Number 96141041, filed Oct. 31, 2007, which is herein incorporated by reference.

### BACKGROUND

1. Field of Invention

The present invention relates to a charge pump system and a method of operating the same. More particularly, the present invention relates to a charge pump system and a method of operating the same in a liquid crystal display.

2. Description of Related Art

A liquid crystal display typically includes a charge pump system for generating a positive output voltage that is two or three times a power supply voltage, or for generating a negative output voltage that is two or three times the power supply voltage, so as to be provided for drivers or other circuits of the liquid crystal display. The charge pump system typically includes a charge pump and a level shifter, in which the level shifter pulls up levels of clock signals to generate clock signals with different amplitudes for the charge pump, such that the charge pump can thus generate output voltages with different levels. The charge pump transfers the power supply voltage into the output voltages, which are two or three times the power supply voltage, according to the clock signals with different amplitudes generated by the level shifter, and then provides the output voltages for the level shifter. Therefore, the charge pump and the level shifter relate to each other and form a circuit with cogeneration.

However, when the whole system just starts or the power supply voltage increases gradually from 0 V at the beginning, the initial value of the power supply voltage can probably be unstable or too small, such that the charge pump cannot provide necessary voltages for the level shifter and the level shifter cannot be operated properly. When the level shifter cannot be operated properly, the charge pump cannot output required voltages based on the clock signals generated by the level shifter.

### SUMMARY

In accordance with one embodiment of the present invention, a charge pump system is provided. The charge pump system includes a charge pump circuit, a level shifter and a start circuit. The charge pump circuit has a voltage input terminal and a voltage output terminal. The charge pump circuit receives an input voltage at the voltage input terminal and generates an output voltage at the voltage output terminal. The level shifter is electrically coupled to the voltage output terminal of the charge pump circuit. The start circuit is electrically coupled between the voltage input terminal and the voltage output terminal of the charge pump circuit.

In accordance with another embodiment of the present invention, a method of operating the charge pump system described above is provided. The method includes the steps of: providing an input voltage to activate the charge pump circuit such that the charge pump circuit generates an output voltage at the voltage output terminal; determining if the output voltage being lower than a predetermined voltage; and activating the start circuit to generate a start voltage at the voltage output terminal to drive the level shifter when the output voltage being lower than the predetermined voltage.

It is to be understood that both the foregoing general description and the following detailed description are by examples, and are intended to provide further explanation of the invention as claimed.

### BRIEF DESCRIPTION OF THE DRAWINGS

The invention can be more fully understood through the following detailed description of the embodiments, with reference made to the accompanying drawings, where:

FIG. 1 shows a charge pump system in a liquid crystal display according to a first embodiment of the present invention;

FIG. 2 shows a charge pump system in a liquid crystal display according to a second embodiment of the present invention;

FIG. 3 shows a charge pump system in a liquid crystal display according to a third embodiment of the present invention;

FIG. 4 shows a charge pump system in a liquid crystal display according to a fourth embodiment of the present invention;

FIG. 5 shows a charge pump system in a liquid crystal display according to a fifth embodiment of the present invention; and

FIG. 6 shows a flow chart of the method of operating the foregoing charge pump system according to one embodiment of the present invention.

### DESCRIPTION OF THE PREFERRED EMBODIMENTS

In the following detailed description, the embodiments of the present invention have been shown and described. As will be realized, the invention is capable of modification in various obvious respects, all without departing from the invention. Accordingly, the drawings and description are to be regarded as illustrative in nature, and not restrictive.

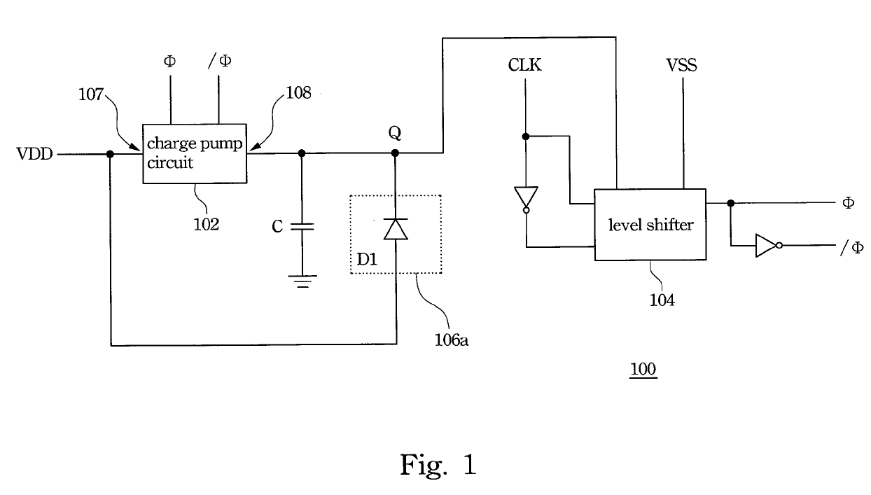

FIG. 1 shows a charge pump system in a liquid crystal display according to a first embodiment of the present invention. The charge pump system 100 includes a charge pump circuit 102, a level shifter 104 and a start circuit 106a. The charge pump circuit 102 has a voltage input terminal 107 and a voltage output terminal 108, and receives an input voltage VDD at the voltage input terminal 107 to generate an output voltage at the voltage output terminal 108, in which the input voltage VDD can be obtained from the power supply voltage for the liquid crystal display. The level shifter 104 is electrically coupled to the voltage output terminal 108 of the charge pump circuit 102, and pulls up a level of a clock signal CLK to generate clock signals φ and /φ. Then, the level shifter 104 transmits the clock signals φ and /φ to the charge pump circuit 102 to be used. The start circuit 106a is electrically coupled between the input voltage VDD and the voltage output terminal 108 of the charge pump circuit 102, in which the start circuit 106a and the voltage output terminal 108 are coupled at the node Q. When the output voltage generated by the charge pump circuit 102 is lower than a predetermined voltage, the start circuit 106a activates and generates a start voltage at the voltage output terminal 108, i.e. node Q, to drive the level shifter 104. Furthermore, when the output voltage generated by the charge pump circuit 102 is higher than or approximately equal to the predetermined voltage, the start circuit 106a deactivates and stops generating the start voltage. At this moment, the level shifter 104 is directly driven by the output voltage generated by the charge pump circuit 102.

In the present embodiment, the start circuit 106a includes a diode D1. The diode D1 has an anode electrically coupled to the input voltage VDD and a cathode electrically coupled to the voltage output terminal 108 of the charge pump circuit 102, i.e. the node Q. When the output voltage generated by the charge pump circuit 102 is lower than the input voltage VDD; that is, when the voltage of the node Q is lower than the input voltage VDD in the ideal condition, the diode D1 is turned on and in the forward operation, such that the node Q therefore has the same voltage as the input voltage VDD, so as to activate the level shifter 104 and make the level shifter 104 operate properly. On the other hand, when the output voltage generated by the charge pump circuit 102 increases gradually with time to be higher than or approximately equal to the input voltage VDD; that is, when the voltage of the node Q is higher than or equal to the input voltage VDD in the ideal condition, the diode D1 is turned off in the reverse operation, such that the level shifter 104 is directly activated by the output voltage generated by the charge pump circuit 102.

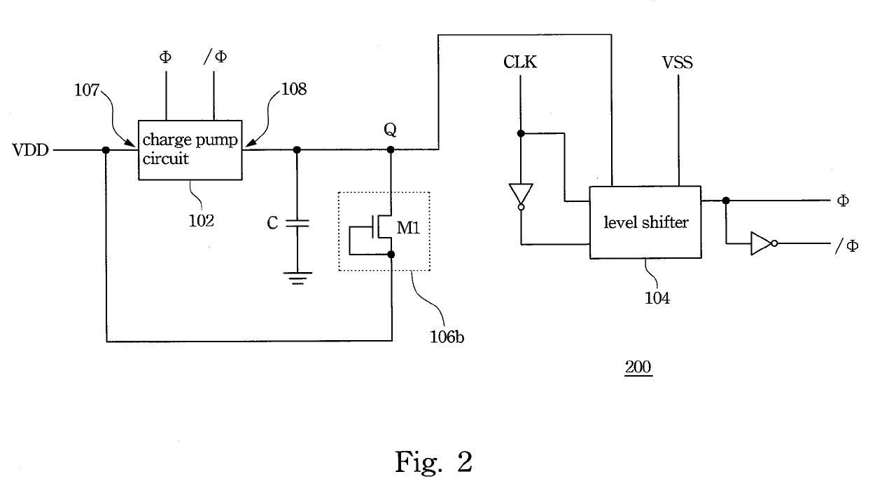

FIG. 2 shows a charge pump system in a liquid crystal display according to a second embodiment of the present invention. Compared to FIG. 1, the start circuit 1 06b of the charge pump system 200 includes an N-type metal-oxide-semiconductor field effect transistor (MOSFET) M1. The transistor M1 has a gate and a first source/drain both electrically coupled to the input voltage VDD and a second source/drain electrically coupled to the voltage output terminal 108 of the charge pump circuit 102, i.e. the node Q. When the output voltage generated by the charge pump circuit 102 is lower than the input voltage VDD; that is, when the voltage of the node Q is lower than the input voltage VDD in the ideal condition, the transistor Ml is turned on such that the node Q therefore has the same voltage as the input voltage VDD, so as to activate the level shifter 104 and make the level shifter 104 operate properly. On the other hand, when the output voltage generated by the charge pump circuit 102 increases gradually with time to be higher than or approximately equal to the input voltage VDD; that is, when the voltage of the node Q is higher than or equal to the input voltage VDD in the ideal condition, the transistor M1 is turned off such that the level shifter 104 is directly activated by the output voltage generated by the charge pump circuit 102.

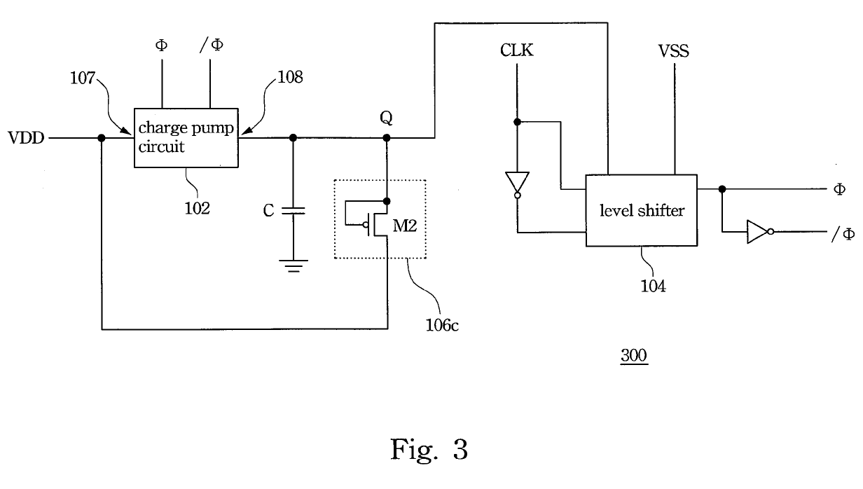

FIG. 3 shows a charge pump system in a liquid crystal display according to a third embodiment of the present invention. Compared to FIG. 1, the start circuit 106c of the charge pump system 300 includes a P-type MOSFET M2. The transistor M2 has a gate and a first source/drain both electrically coupled to the voltage output terminal 108 of the charge pump circuit 102, i.e. the node Q, and a second source/drain electrically coupled to the input voltage VDD. When the output voltage generated by the charge pump circuit 102 is lower than the input voltage VDD; that is, when the voltage of the node Q is lower than the input voltage VDD in the ideal condition, the transistor M2 is turned on such that the node Q therefore has the same voltage as the input voltage VDD, so as to activate the level shifter 104 and make the level shifter 104 operate properly. On the other hand, when the output voltage generated by the charge pump circuit 102 increases gradually with time to be higher than or approximately equal to the input voltage VDD; that is, when the voltage of the node Q is higher than or equal to the input voltage VDD in the ideal condition, the transistor M2 is turned off such that the level shifter 104 is directly activated by the output voltage generated by the charge pump circuit 102.

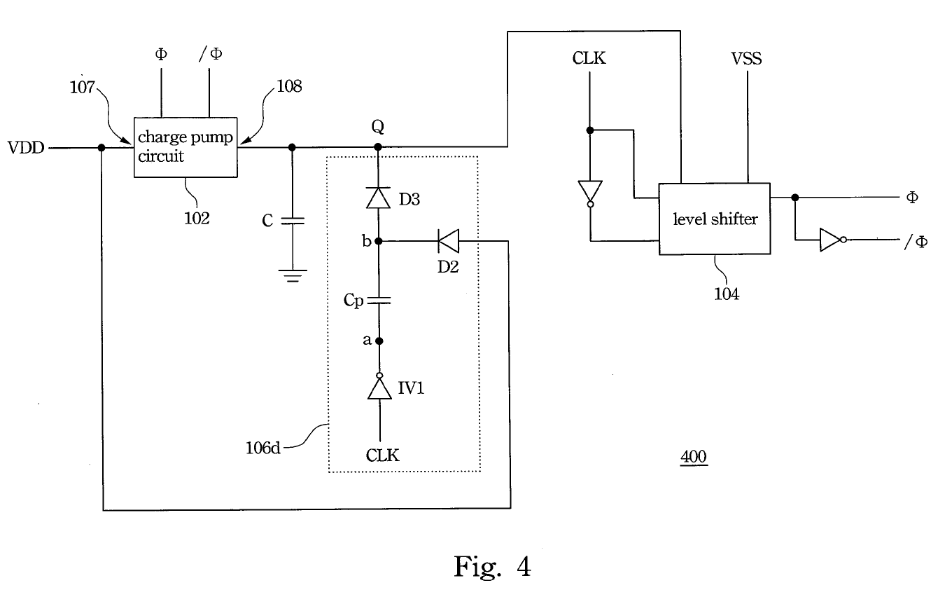

FIG. 4 shows a charge pump system in a liquid crystal display according to a fourth embodiment of the present invention. Compared to FIG. 1, the start circuit 106d of the charge pump system 400 includes an inverter IV1, an energy storing element Cp and two diodes D2 and D3. In one embodiment, the energy storing element Cp is a capacitor. The inverter IV1 has an input terminal and an output terminal, in which the inverter IV1 receives the clock signal CLK from the input terminal, and the output terminal is electrically coupled to one end of the energy storing element Cp. The other end of the energy storing element Cp is electrically coupled to the cathode of the diode D2 and the anode of the diode D3, i.e. the node b. The anode of the diode D2 is electrically coupled to the input voltage VDD, and the cathode of the diode D3 is electrically coupled to the voltage output terminal 108 of the charge pump circuit 102, i.e. the node Q.

In the ideal condition, when the output voltage generated by the charge pump circuit 102 is lower than the input voltage VDD (i.e. when the voltage of the node Q is lower than the input voltage VDD) and when the clock signal CLK is at a high level, the voltage level of the output terminal of the inverter IV1, i.e. the node a, is at a low level and the diode D2 is turned on and in the forward operation, such that the node b has the same voltage as the input voltage VDD. At this moment, the diode D3 is turned on and in the forward operation as well, such that the node Q also has the same voltage as the input voltage VDD. The energy storing element Cp therefore stores the same voltage as the input voltage VDD.

When the clock signal CLK is at a low level, the voltage level of the output terminal of the inverter IV1, i.e. the node a, is at a high level, and the voltage of the node b increases up to 2VDD because of the voltage stored in the energy storing element Cp, such that the diode D2 is turned off and in the reverse operation. At this moment, the diode D3 is still turned on and in the forward operation, such that the voltage of the node Q is 2VDD as well, so as to activate the level shifter 104 and make sure the level shifter 104 operates properly.

On the other hand, when the output voltage generated by the charge pump circuit 102 increases gradually with time up to the voltage which is higher than or approximately equal to 2VDD; that is, when the voltage of the node Q is higher than or equal to 2VDD in the ideal condition, the diode D3 is turned off and in the reverse operation. At this moment, the level shifter 104 is directly activated by the output voltage generated by the charge pump circuit 102.

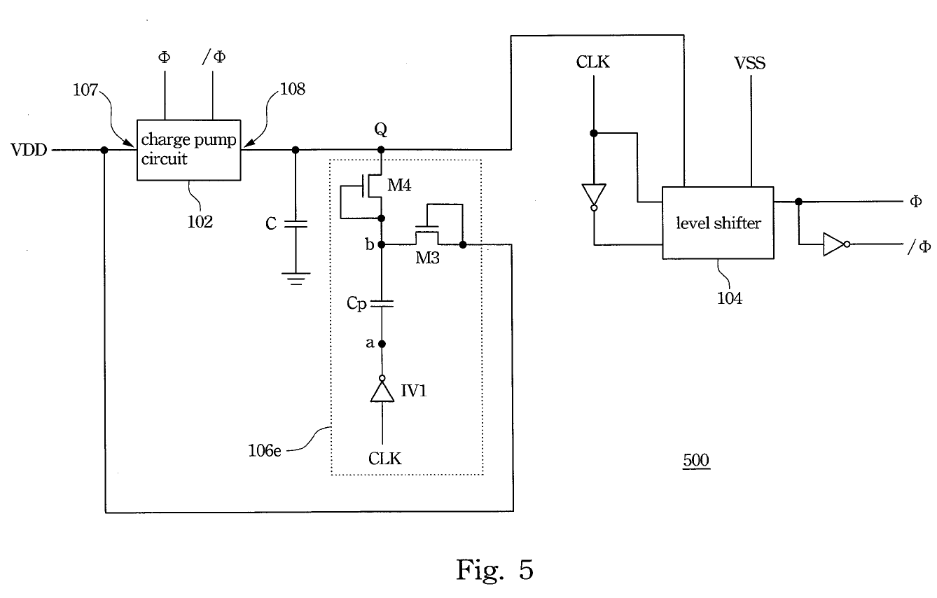

FIG. 5 shows a charge pump system in a liquid crystal display according to a fifth embodiment of the present invention. Compared to FIG. 4, the start circuit 106e of the charge pump system 500 includes the inverter IV1, the energy storing element Cp and two MOSFETs M3 and M4. The input terminal of the inverter IV1 receives the clock signal CLK and the output terminal of the inverter IV1 is electrically coupled to one end of the energy storing element Cp. The other end of the energy storing element Cp is electrically coupled to the second source/drain of the transistor M3 and the gate and first source/drain of the transistor M4 at the node b. The gate and first source/drain of the transistor M3 is electrically coupled to the input voltage VDD. The second source/drain of the transistor M4 is electrically coupled to the voltage output terminal 108 of the charge pump circuit 102, i.e. the node Q.

In the ideal condition, when the output voltage generated by the charge pump circuit 102 is lower than the input voltage VDD (i.e. when the voltage of the node Q is lower than the input voltage VDD) and when the clock signal CLK is at a high level, the voltage level of the output terminal of the inverter IV1, i.e. the node a, is at a low level and the transistor M3 is turned on, such that the node b has the same voltage as the input voltage VDD. At this moment, the transistor M4 is turned on as well, such that the node Q also has the same voltage as the input voltage VDD. The energy storing element Cp therefore stores the same voltage as the input voltage VDD.

When the clock signal CLK is at a low level, the voltage level of the output terminal of the inverter IV1, i.e. the node a, is at a high level and the voltage of the node b increases up to 2VDD because of the voltage stored by the energy storing element Cp, such that the transistor M3 is turned off. At this moment, the transistor M4 is still turned on such that the voltage of the node Q is 2VDD as well, so as to activate the level shifter 104 and make sure the level shifter 104 operates properly.

On the other hand, when the output voltage generated by the charge pump circuit 102 increases gradually with time up to the voltage which is higher than or approximately equal to 2VDD; that is, when the voltage of the node Q is higher than or equal to 2VDD in the ideal condition, the transistor M4 is turned off. At this moment, the level shifter 104 is directly activated by the output voltage generated by the charge pump circuit 102.

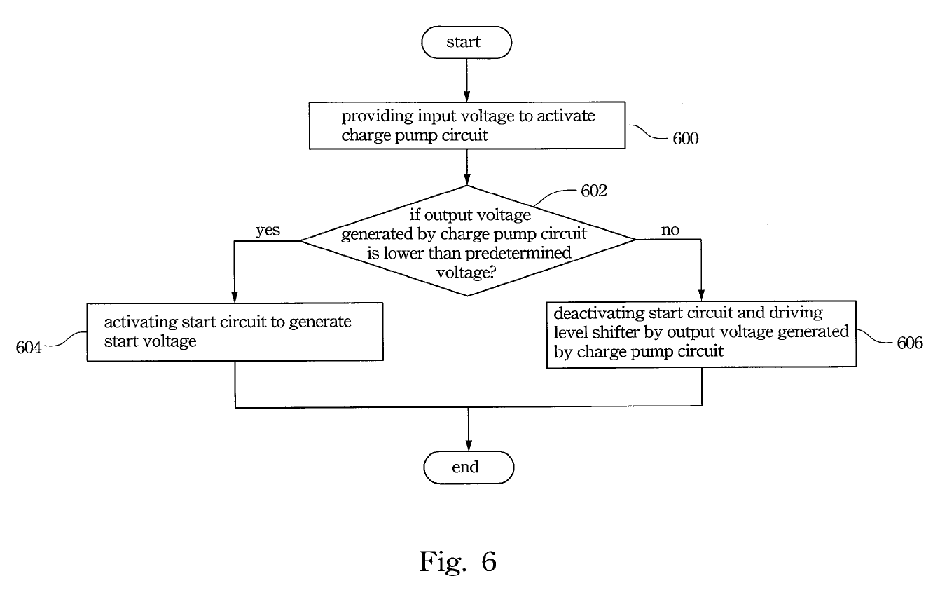

FIG. 6 shows a flow chart of the method of operating the foregoing charge pump system according to one embodiment of the present invention. The embodiment shown in FIG. 1 is used as an example to describe the method as follows. Refer to FIG. 1 and FIG. 6. First, the input voltage VDD is provided to the charge pump circuit 102, so as to activate the charge pump circuit 102 (Step 600), such that the charge pump circuit 102 generates an output voltage at the voltage output terminal 108. Then, whether the output voltage generated by the charge pump circuit 102 is lower than a predetermined voltage is determined (Step 602). When the output voltage generated by the charge pump circuit 102 is lower than the predetermined voltage, the start circuit 160a is activated to generate a start voltage at the voltage output terminal 108, i.e., the node Q, so as to drive the level shifter 104 (Step 604). On the other hand, when the output voltage generated by the charge pump circuit 102 is higher than or equal to the predetermined voltage, the start circuit 160a is deactivated to stop generating the start voltage, and the level shifter 104 is driven by the output voltage generated by the charge pump circuit 102 (Step 606). Furthermore, the level of the clock signal CLK can be pulled up by the level shifter 104 to generate the clock signals φ and /φ, and the clock signals φ and /φ can be transmitted to the charge pump circuit 102 to be used. As a result, the problem, that the charge pump system cannot be operated properly when the whole system is unstable or the power supply voltage increases gradually from 0 V at the beginning, can be overcome.

For the foregoing embodiments of the present invention, the charge pump system and the method of operating the same can be applied such that the charge pump system is stable and operated properly when the whole system is unstable or the power supply voltage increases gradually from 0 V at the beginning, so as to output a stable voltage and significantly reduce the instability of the charge pump system.

Moreover, the foregoing start circuit can be applied to provide a stable voltage in the initial state and be deactivated after the whole system is stable. Therefore, the extra power loss is not necessary. Additionally, the charge pump system does not need other control signals to be controlled, so the control circuit in the liquid crystal display will not have a burden.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A charge pump system, comprising:
a charge pump circuit having a voltage input terminal and a voltage output terminal, the charge pump circuit receiving an input voltage at the voltage input terminal and generating an output voltage at the voltage output terminal;
a level shifter electrically coupled to the voltage output terminal of the charge pump circuit; and
a start circuit electrically coupled between the voltage input terminal and the voltage output terminal of the charge pump circuit.

2. The charge pump system as claimed in claim 1, wherein when the output voltage generated by the charge pump circuit is lower than a predetermined voltage, the start circuit activates and generates a start voltage at the voltage output terminal of the charge pump circuit to drive the level shifter.

3. The charge pump system as claimed in claim 2, wherein when the output voltage generated by the charge pump circuit is higher than or equal to the predetermined voltage, the start circuit deactivates and stops generating the start voltage.

4. The charge pump system as claimed in claim 1, wherein the start circuit further comprises:
a diode having an anode electrically coupled to the input voltage and a cathode electrically coupled to the voltage output terminal of the charge pump circuit.

5. The charge pump system as claimed in claim 1, wherein the start circuit further comprises:
an N-type metal-oxide-semiconductor field effect transistor (MOSFET), the N-type MOSFET having a gate and a first source/drain both electrically coupled to the input voltage and a second source/drain electrically coupled to the voltage output terminal of the charge pump circuit.

6. The charge pump system as claimed in claim 1, wherein the start circuit further comprises:
a P-type metal-oxide-semiconductor field effect transistor (MOSFET), the P-type MOSFET having a gate and a first source/drain both electrically coupled to the voltage output terminal of the charge pump circuit and a second source/drain electrically coupled to the input voltage.

7. The charge pump system as claimed in claim 1, wherein the start circuit further comprises:
an inverter having an input terminal and an output terminal, the input terminal of the inverter receiving a first clock signal;
an energy storing element having a first terminal and a second terminal, the first terminal of the energy storing element electrically coupled to the output terminal of the inverter;
a first diode having a first anode and a first cathode, the first anode of the first diode electrically coupled to the input voltage, the first cathode of the first diode electrically coupled to the second terminal of the energy storing element; and
a second diode having a second anode and a second cathode, the second anode of the second diode electrically coupled to the second terminal of the energy storing element, the second cathode of the second diode electrically coupled to the voltage output terminal of the charge pump circuit.

8. The charge pump system as claimed in claim 1, wherein the start circuit further comprises:
an inverter having an input terminal and an output terminal, the input terminal of the inverter receiving a first clock signal;
an energy storing element having a first terminal and a second terminal, the first terminal of the energy storing element electrically coupled to the output terminal of the inverter;
a first N-type metal-oxide-semiconductor field effect transistor (MOSFET) having a gate and a first source/drain both electrically coupled to the input voltage and a second source/drain electrically coupled to the second terminal of the energy storing element; and
a second N-type MOSFET having a gate and a first source/drain both electrically coupled to the second terminal of the energy storing element and a second source/drain electrically coupled to the voltage output terminal of the charge pump circuit.

9. The charge pump system as claimed in claim 1, wherein the level shifter pulls up a level of at least one clock signal and transmits the pulled-up clock signal to the charge pump circuit.

10. A method of operating the charge pump system as claimed in claim 1, the method comprising the steps of:
providing an input voltage to activate the charge pump circuit such that the charge pump circuit generating an output voltage at the voltage output terminal;
determining if the output voltage being lower than a predetermined voltage; and
activating the start circuit to generate a start voltage at the voltage output terminal to drive the level shifter when the output voltage being lower than the predetermined voltage.

11. The method as claimed in claim 10, further comprising the step of:
deactivating the start circuit to stop generating the start voltage when the output voltage being higher than or equal to the predetermined voltage.

12. The method as claimed in claim 11, further comprising the step of:
driving the level shifter by the output voltage when the output voltage being higher than or equal to the predetermined voltage.

13. The method as claimed in claim 10, further comprising the steps of:
pulling up levels of a plurality of clock signals by the level shifter; and
transmitting the pulled-up clock signals to the charge pump circuit.
